(19) United States
(12) Patent Application Publication
(10) Pub. No.: US 2022/0366473 A1
(43) Pub. Date: Nov. 17, 2022

(54) INFORMATION PROCESSING SYSTEM, INFORMATION PROCESSING METHOD AND PROGRAM

(71) Applicant: Rakuten Group, Inc., Tokyo (JP)

(72) Inventors: Neil PRIMOZICH, Tokyo (JP); Josue SIOW, Tokyo (JP); Vincent MICHEL, Paris (FR); Yannick SCHWARTZ, Paris (FR); Mohamed Ali JAMAOUI, Paris (FR); Mederich BESNARD, Paris (FR); Karl POTISEPP, Paris (FR); Julien NIVET, Paris (FR); Phuc Quang LE, Tokyo (JP); Haekyung WON, Tokyo (JP); Mahesh SHINDE, Tokyo (JP); Gilles DARTIGUELONGUE, Paris (FR); Jiahong CHEN, Tokyo (JP)

(73) Assignee: Rakuten Group, Inc., Tokyo (JP)

(21) Appl. No.: 17/488,555

(22) Filed: Sep. 29, 2021

(30) Foreign Application Priority Data
May 13, 2021 (JP) 2021-081624
May 13, 2021 (JP) 2021-081625

(51) Int. Cl. G06Q 30/06

(52) U.S. Cl. CPC G06Q 30/0631; G06Q 30/0643; G06Q 30/0633

(57) ABSTRACT

An information processing system acquires an action history including at least one of a purchase history including an item purchased by a user and a browsing history including an item browsed by the user, selects one or more items from the plurality of items as a first item by a first selection method based on the acquired action history, selects one or more items from the plurality of items as a second item by a second selection method different from the first selection method based on the acquired action history, and adds the first item and the second item to the same list.

### CROSS REFERENCE TO RELATED APPLICATIONS

This application claims priority to Japanese Patent Application No. JP 2021-081624 filed on May 13, 2021 and Japanese Patent Application No. 2021-081625 filed on May 13, 2021, the entire disclosures of which are incorporated herein by reference.

### BACKGROUND

The present disclosure relates to an information processing system, an information processing method and a program.

For example, in the sale of merchandise via the Internet, there is a system for recommending merchandise according to the behavior of a user.

Patent document 1 (WO 2017/104064) discloses recommending merchandise based on an action history consisting of a purchase history or a browsing history of a user.

On a website for selling merchandise, merchandise related to the merchandise being displayed to the user in one place is displayed as a recommendation object, and various other merchandise items are also presented in other places. As a result, the burden on the user to refer to the displayed products is increased, and the convenience is reduced.

### SUMMARY

It is an object of the present disclosure to provide a technique for reducing a load on which a user refers to a commodity and to improving usability.

An information processing system according to an embodiment of the disclosure includes: at least one memory configured to store computer program code; and at least one processor configured to execute the computer program code to: acquire an action history of a user in relation to a store, the action history including at least one of a purchase history including an item purchased by the user from the store and a browsing history including an item browsed by the user in the store; select, based on the acquired action history, a first item from among a first plurality of items by a first selection method; select, based on the acquired action history, one or more second items from among a second plurality of items by a second selection method different from the first selection method; add the first item and the one or more second items to a list; and output the list for display to the user on a screen for recommending items of interest to the user and allowing the user to purchase the items via the screen.

In an embodiment of the present disclosure, the information processing system may be configured to arrange the first item and the one or more second items in the list at positions corresponding to recommendation rankings determined therefor.

In an embodiment of the present disclosure, the information processing system may be configured to add to a cart an item selected by the user from among the first item and the one or more second items displayed on the screen.

In an embodiment of the present disclosure, the information processing system may be configured to add the item selected by the user from among the displayed first item and the one or more second items to the cart based on an add button displayed on the screen being pressed.

In an embodiment of the present disclosure, the information processing system may be configured to select at least one of items included in the purchase history as the first item; and select at least one of items different from the items included in the purchase history and different from items included in the browsing history as the one or more second items.

In an embodiment of the present disclosure, the listing means may arrange the first item before the one or more second items in the list.

In an embodiment of the present disclosure, the information processing system may be configured to obtain a repurchase probability value for each of the items included in the purchase history, the repurchase probability value indicative of a probability of repurchase; select as said first item an item included in said purchase history that has a corresponding repurchase probability value determined to satisfy a predetermined condition.

In an embodiment of the present disclosure, the information processing system may be configured to acquire the repurchase probability value based on a past purchase date of the item by the user.

In an embodiment of the present disclosure, the information processing system may be configured to arrange, in the list, an item from among the one or more second items selected based on the purchase history before another item from among the one or more second items selected based the browsing history.

In an embodiment of the present disclosure, the second selection method includes a method for selecting a second item based on a relationship between a first genre of an item included in the action history and a second genre of the second item, and a different method of selecting an other second item based on a relationship between the item included in the action history and the other second item.

In an embodiment of the present disclosure, the information processing system may be configured to select the first item based on a purchase history of the user at another store different from a store to which the user is accessing; and select the one or more second items based a browsing history of the user in the other store.

In an embodiment of the present disclosure, the information processing system may be configured to select the first item from among items included in a purchase history or a browsing history at another store different from a store to which the user is accessing; and select the one or more second items based on the purchase history or the browsing history of the user in the other store.

An information processing method according to an embodiment includes: acquiring an action history of a user in relation to a store, the action history including at least one of a purchase history including an item purchased by the user from the store and a browsing history including an item browsed by the user in the store; selecting, based on the acquired action history, a first item from among a first plurality of items by a first selection method; selecting, based on the acquired action history, one or more second items from among a second plurality of items by a second selection method different from the first selection method; adding the first item and the one or more second items to a list; and outputting the list for display to the user on a screen for recommending items of interest to the user and allowing the user to purchase the items via the screen.

A non-transitory computer-readable medium according to an embodiment stores instructions that, when executed by one or more processors of a device, cause the one or more processors to: acquire an action history of a user in relation to a store, the action history including at least one of a purchase history including an item purchased by the user from the store and a browsing history including an item browsed by the user in the store; select, based on the acquired action history, a first item from among a first plurality of items by a first selection method; select, based on the acquired action history, one or more second items from among a second plurality of items by a second selection method different from the first selection method; add the first item and the second item to a list; and output the list for display to the user on a screen for recommending items of interest to the user and allowing the user to purchase the items via the screen.

Accordingly, aspects of one or more embodiments reduce a burden on a user to refer to merchandise and improve usability, while reducing power consumption and processing time of an information processing system by providing quicker access to a user to items of interest.

### BRIEF DESCRIPTION OF THE DRAWINGS

Features, advantages, and technical and industrial significance of exemplary embodiments of the disclosure will be described below with reference to the accompanying drawings, in which like reference numerals denote like elements. The various features of the drawings may not be to scale as the illustrations are for clarity in facilitating the understanding of one skilled in the art in conjunction with the detailed description.

FIG. 1 shows a hardware configuration of an information processing system according to an embodiment of the present disclosure.

FIG. 2 is a block diagram illustrating operations of an information processing system according to an embodiment.

FIG. 3 is a flow chart of the processing of the overall history acquisition part, the related genre determination part, the related item determination part, and the repurchasability acquisition part according to an embodiment.

FIGS. 4 to 6 are flow charts of the processing of the information processing system according to an embodiment.

FIG. 7 is a flow chart of a processing of the genre utilization part according to an embodiment.

FIG. 8 is a flow chart of a processing of the item utilization part according to an embodiment.

FIG. 9 is a diagram illustrating an example of the relationship between a purchase history in a store S and items added to the list, according to an embodiment.

FIG. 10 is a diagram showing an example of the relationship between a purchase history and a browsing history in the store S and items added to the list, according to an embodiment.

FIG. 11 is a diagram illustrating an example of a relationship between a purchase history and a browsing history and an item added to the list, according to an embodiment.

FIG. 12 shows an example of an output proposal screen, according to an embodiment.

FIG. 13 shows an example of a proposal screen after an item has been added to the cart.

### DETAILED DESCRIPTION

Embodiments of the present disclosure will be described below with reference to the drawings. Overlapping explanations may be omitted for the configurations given the same reference numerals. In an exemplary embodiment, an information processing system for realizing electronic commerce by a plurality of stores (e.g., sellers, vendors, online vendors, etc.) will be described. In the information processing system according to an example embodiment, merchandise is proposed or recommended to a user who accesses a particular store from among the plurality of stores.

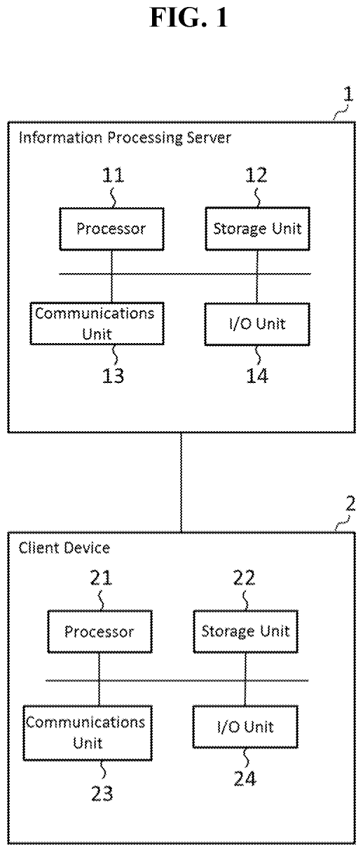

FIG. 1 is a diagram of an information processing system according to an exemplary embodiment of the present disclosure. The information processing system includes an information processing server 1 and a client device 2. The information processing server 1 is connected to one or a plurality of client devices 2 through a network.

The information processing server 1 includes a processor 11, a storage unit 12 (or storage), a communication unit 13 (or communicator), and an input/output (I/O) unit 14 (or I/O device). The information processing server 1 is a server computer. The processing of the information processing server 1 may be realized by one or a plurality of server computers. The client device 2 includes a processor 21, a storage unit 22 (or storage), a communication unit 23 (or communicator), and an input/output unit 24 (or I/O device). The client device 2 may be a personal computer, a smart phone, a tablet terminal, a personal multimedia player, a display device, a netbook, a mobile device, a console, a television, etc., but is not limited thereto.

The processors 11 and 21 operate according to programs and/or executable instructions stored in the storage units 12 and 22. The processors 11 and 21 control the communication units 13 and 23 and the input/output units 14 and 24. The program may be provided via the Internet or stored in a computer-readable storage medium such as a flash memory or an optical storage medium (e.g., a DVD-ROM). The processors 11 and 21 may each correspond to one or more processors.

The storage units 12 and 22 are composed of a memory element such as random access memory (RAM), a flash memory, etc., and/or an external storage device such as a hard disk drive. The storage units 12 and 22 store the programs and/or executable instructions. The storage units 12 and 22 store information and calculation results inputted from the processors 11 and 21, the communication units 13 and 23, and the input/output units 14 and 24.

The communication units 13 and 23 communicate with other devices, and are composed of, for example, at least one of a wireless local area network (LAN) interface or an integrated circuit for realizing a wired LAN. Based on the control of the processors 11 and 21, the communication units 13 and 23 input information received from other devices to the processors 11 and 21 and the storage units 12 and 22, and transmit the information to the other devices.

The input/output units 14 and 24 include a video controller for controlling the display output device, a controller for acquiring data from an input device, and the like. The input device may include at least one of a keyboard, a mouse, a touch panel or pad, one or more buttons, a rotatable dial, a voice input device (e.g., microphone), a gesture recognition device, etc. Input/output units 14 and 24 output display data to a display output device under the control of processors 11 and 21, and acquire data inputted by the user operating an input device. The display output device is, for example, a display device that is internal or external to the corresponding device 1, 2.

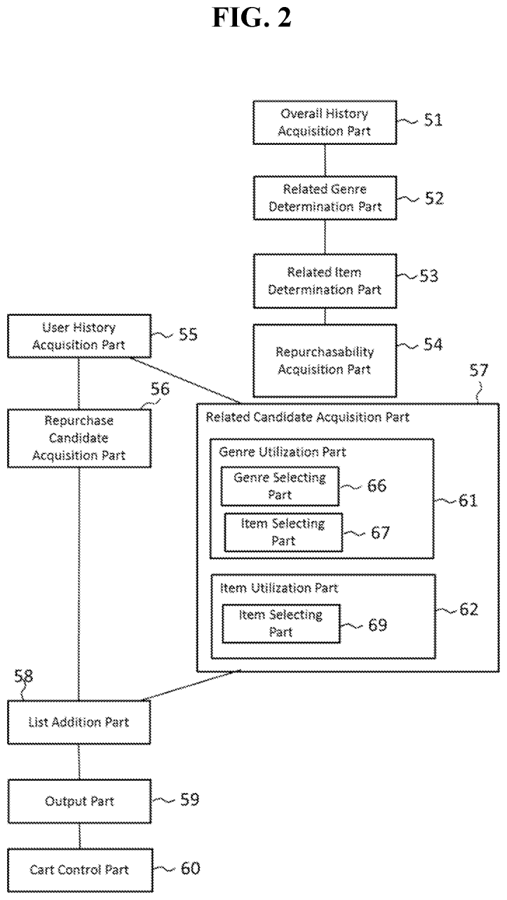

Next, operations of the information processing system will be described with reference to FIG. 2. FIG. 2 is a block diagram showing operations of the information processing system. The information processing system includes an overall history acquisition part 51, a related genre determination part 52, a related item determination part 53, a repurchasability acquisition part 54, a user history acquisition part 55, a repurchase candidate acquisition part 56, a related candidate acquisition part 57, a list addition part 58, an output part 59, and a cart control part 60. These operations are realized as instructions stored in the storage unit 12 and executed by a processor 11 (i.e., one or more processors) included in the information processing server 1 and controlling the communication unit 13 and the like. Further, at least some of the functions of the output unit 59 may be realized as instructions stored in the storage unit 22 and executed by a processor 21 (i.e., one or more processors) included in the client device 2 and controlling the communication unit 23 and the input/output unit 24. The related candidate acquisition part 57 functionally includes a genre utilization part 61 and an item utilization part 62. Functionally, the genre using part 61 includes a genre selecting part 66 and an item selecting part 67, and the item utilization part 62 includes an item selecting part 69.

The overall history acquisition part 51 acquires at least one of a purchase history and a browsing history of the user. The purchase history includes information indicating a purchasing user and one or more combinations of items purchased together by the user. The browsing history includes information indicating a browsing user and one or more combinations of items browsed together by the user. For example, items viewed within a predetermined period (for example, on the same day) may be items viewed together. The purchase history and the browsing history are stored in a storage part 12 for a plurality of users (for example, all users or a predetermined group or grouping of users) using the information processing system. The overall history acquisition part 51 may acquire all of the purchase history and the browsing history stored in the storage unit 12, or may acquire the purchase history and the browsing history of a specific store, a specific category of stores, a specific location, and/or a specific time period.

The related genre determination part 52 determines a set of related genres based on the genres of the items constituting the combinations included in the acquired purchase history and/or the acquired browsing history.

The related item determination part 53 determines a set of related items based on items included in the combinations of the acquired purchase history and/or the acquired browsing history.

The repurchasability acquisition part 54 (or repurchase possibility acquisition part 54) calculates a repurchase possibility for each item based on the acquired purchase history.

The user history acquisition part 55 acquires an action history including at least one of a purchase history including an item purchased by a certain user and a browsing history including an item browsed by the user.

The repurchase candidate acquisition part 56 selects at least one item among items included in a purchase history of the user as a repurchase candidate(s).

The related candidate acquisition part 57 selects at least one item different from the item included in the purchase history and the browsing history of the user as a related candidate. A method for acquiring an item as a repurchase candidate in the repurchase candidate acquisition part 56 is different from a method for selecting an item as a related candidate by the related candidate acquisition part 57.

The genre utilization part 61 included in the related candidate acquisition part 57 selects a genre related to the genre to which the item purchased or browsed by the user belongs, and acquires any of the items belonging to the selected genre as a related candidate to be recommended to the user.

The genre selecting part 66 included in the genre utilization part 61 selects or obtains a related genre, which is a genre related to the genre to which the item purchased or browsed by the user belongs based on the acquired set of related genres.

The item selecting part 67 included in the genre utilization part 61 acquires any item included in the selected genre as a related candidate to be recommended to the user. For example, the item selecting part 67 acquires or determines the item most frequently purchased or browsed among the items belonging to the selected genre as the related candidate. The item selecting part 67 may acquire an item whose sale has started within a predetermined period as a related candidate. Here, the predetermined period may be a period such as the past one month or one week.

The item utilization part 62 included in the related candidate acquisition part 57 selects one or more items related to an item purchased or browsed by a user, and acquires or determines the selected item(s) as a related candidate(s) to be recommended to the user.

The item selecting part 69 included in the item utilization part 62 acquires one or more items related to items purchased or browsed by the user as a related candidate(s) on the basis of the acquired set of items related to each other.

The list addition part 58 adds the selected re-purchase candidate(s) and related candidates to a list (e.g., a list corresponding to a user for identifying, proposing or suggesting items to the user). For example, the list addition part 58 may add the repurchase candidate(s) and the related candidates to the list so that the repurchase candidate(s) is listed before the related candidates.

The output part 59 displays an image in which items included in the list are arranged at positions corresponding to the order of items in the list. When the output part 59 consists only of the information processing server 1, image data is transmitted to the client device 2 to be displayed. When the output part 59 also includes the client device 2, the image is displayed on the display device of (or connected to) the client device 2.

The cart control part 60 adds to a virtual shopping cart an item indicated or selected by the user among the items included and displayed in the list.

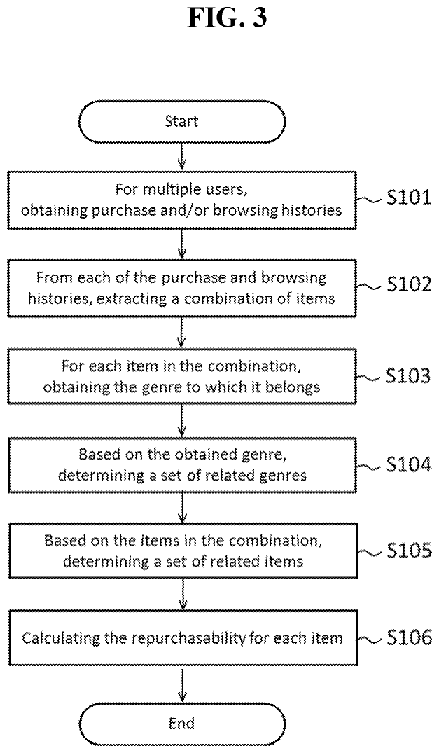

Next, the processing of the information processing system will be described in detail with reference to FIG. 3. FIG. 3 is a flow chart showing an example of the processing of the overall history acquisition part 51, the related genre determination part 52, the related item determination part 53, and the repurchasability acquisition part 54. The process shown in FIG. 3 may be performed once in advance, or may be repeated at predetermined intervals.

Referring to FIG. 3, the overall history acquisition part 51 acquires purchase histories and/or browsing histories of a plurality of users (Operation S101). The overall history acquisition part 51 may acquire the purchase history and/or the browsing history stored in the storage unit 12 for any user of a certain store, or may acquire the purchase history and/or the browsing history stored in the storage unit 12 for all stores managed by the information processing system. The acquired purchase history and browsing history may be the purchase history and browsing history within a predetermined time period, e.g., within the past year.

Next, the related genre determination part 52 extracts or obtains a combination of items purchased together from the acquired purchase history, and/or extracts or obtains a combination of items browsed together from the acquired browsing history (Operation S102). Further, the related genre determination part 52 acquires genres to which each of the items included in the extracted combination(s) belongs (Operation S103). The genre may have a hierarchical structure, and the related genre determination part 52 may acquire the genre of the lowest tier (e.g., third tier if hierarchy is three-tiered). The genre used here may be a genre in a certain store or a genre common to all stores.

The related genre determination part 52 determines a set of related genres (e.g., related to each other) on the basis of genres to which respective items included in the combination belong (Operation S104). The related genre determination part 52 compiles or obtains a set of genres to which items included in the combination belong, and determines a set of genres related to each other based on the total number of the obtained set of genres. For example, when (or based on) the number of sets of genres is larger than a threshold value (or predetermined threshold value), the related genre determination unit 52 may determine the set of the genres as a set of genres related to each other.

The related item determination part 53 determines a set of items related to each other based on the items included in the extracted combination(s) (Operation S105). For example, the related item determination part 53 may count the number of occurrences of the combination in the corresponding history and determine a set of items related to each other based on the counted number of occurrences. For example, when the number of occurrences of a particular combination is greater than a threshold value, the related item determination unit 53 may determine that the items included in the combination are a set of items related to each other.

The related genre determination part 52 may determine a set of genres to which each of the items included in the set of items related to each other belongs as a set of genres related to each other for the set of mutually related items determined by the related item determination part 53.

The repurchasability acquisition part 54 calculates or obtains a repurchasability value for each item (Operation S106). For example, the repurchasability may be a repurchase rate that is a ratio of the users who purchased the item to the users who purchased the item multiple times. Note that the repurchasability acquisition part 54 may store the item that satisfies a predetermined repurchasability condition, e.g., whose calculated or obtained repurchasability is greater than a threshold value, in the storage unit 12 as an item having a high repurchasability.

The repurchasability may also be predicted using a learning model (e.g., a machine learning model). A repurchasability acquisition part 54 acquires repurchase possibility on the basis of the past purchase date of the item by the user. Specifically, the repurchasability acquisition part 54 acquires the repurchasability of the item by using a learning model for outputting the repurchasability of the item with the past purchase date of the item as an input. The learning model is generated by supervised machine learning which uses a machine learning algorithm such as a neural network to learn the relationship between the past purchase date of an item purchased by a user and the presence/absence of repurchase by the user as training data. The repurchasability acquisition part 54 may store an item satisfying a predetermined condition of repurchasability among items included in the purchase history of the user in the storage unit 12 as an item having a high possibility of repurchase. For example, in the case where the learning model outputs the repurchasability as a numerical value, an item whose repurchasability is larger than a threshold value may be an item with a high repurchasability. When the learning model outputs the binary classified value (high or low) as the possibility of repurchase, an item that satisfies a predetermined repurchasability condition, e.g. which is classified high, may be determined as an item with a high repurchasability.

There is a relationship between past purchase dates and repurchasability of an item. For example, items that the user has recently purchased or items that the user has previously purchased tend to be less likely to be repurchased because the user is less willing to purchase again at this time. On the other hand, items that the user regularly purchases tend to have a high possibility of being repurchased at the next purchase time. The possibility of the user's repurchase can be determined with high accuracy by using a learning model in which the past purchase date of the item and the existence of repurchase are learned.

The input data of the learning model is not limited to the past purchase date of the item. For example, the input data may be or may further include a repurchase rate. Thus, a prediction reflecting the repurchase result of each item can be performed. Further, the input data may be the number of past item purchases by the user. Thus, a prediction reflecting purchase results of the items for each user can be performed. Moreover, the input data may be the number of previous item purchases by the user. Thus, a prediction reflecting the period between the previous purchase time and the next purchase time, which changes according to the number of previous purchase items, can be made. Also, the input data may be the price of the item. This allows the model to make predictions that reflect the item's price, such that high-priced items are less likely to be repurchased. By way of additional example, the input data may be the repurchase rate of the genre to which the item belongs. Thus, even for an item with a small purchase result, a prediction reflecting the repurchase rate of a genre correlated with the repurchase rate of the item can be performed. A plurality of input data among the input data may be input data of the learning model. By using a learning model in which the relation between the input data and the presence/absence of the repurchase by the user is learned as training data, the possibility of the user's repurchase can be determined with high accuracy.

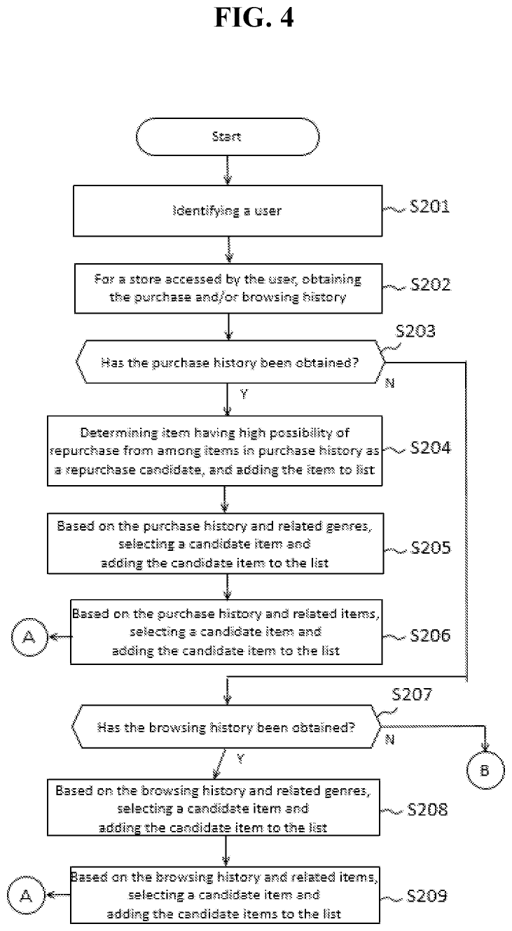

Next, processing performed when a user accesses a sales page of a store in the information processing system will be described with reference to FIGS. 4 to 6. FIGS. 4 to 6 are flow charts showing an example of processing relating to sale to a user. FIGS. 4 to 6 show an outline of the processes of the user history acquisition part 55, the repurchase candidate acquisition part 56, the related candidate acquisition part 57, the list addition part 58, the output part 59, and the cart control part 60.

First, the user history acquisition part 55 identifies a user who has accessed the information processing server 1 (Operation S201), and obtains a purchase history and/or a browsing history in a store accessed by the user (Operation S202).

Based on the purchase history being acquired (Y in Operation S203), the repurchase candidate acquisition part 56 selects or determines an item having a high possibility of repurchase (e.g., an obtained repurchase probability value that is greater than a predetermined threshold) among the items included in the acquired purchase history as a repurchase candidate. The list addition part 58 adds the selected item to a list (Operation S204).

Further, the genre utilization part 61 included in the related candidate acquisition part 57 selects a candidate item from among a plurality of items handled (or sold) by the store based on the purchase history and the related genres, and the list addition part 58 adds the selected candidate item to the list (Operation S205).

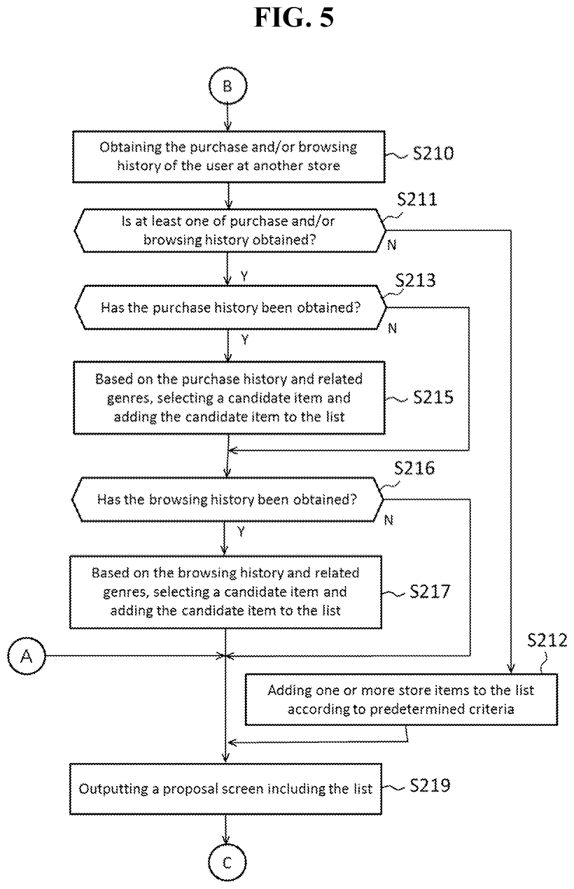

The item utilization part 62 included in the related candidate acquisition part 57 selects or determines a candidate item from a plurality of items handled by the store based on the purchase history and the related items, and the list addition part 58 adds the selected candidate item to the list (Operation S206). According to an embodiment, the list addition part 58 may add items so that the item added in Operation S204 is ordered before the items added in Operations S205 and S206. Based on the processes in Operations S204 to S206 being performed, the process proceeds to Operation S219 (FIG. 5).

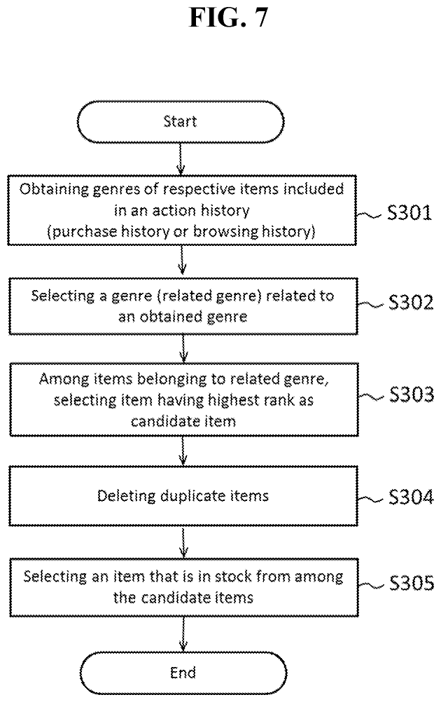

The processing of Operation S205 will now be described in detail with reference to FIG. 7. FIG. 7 is a diagram showing a detailed example of the processing of the genre utilization part 61. First, the genre selecting part 66 included in the genre utilization part 61 acquires genres of respective items included in an action history that is one of a purchase history or a browsing history (Operation S301). For example, in Operation S205, the action history is a purchase history.

The genre selection part 66 selects a genre (related genre) related to an acquired genre based on the set of a plurality of genres related to each other determined by the related genre determination part 52 (Operation S302).

The item selecting part 67 selects or determines an item having a highest rank among items belonging to the related genre and handled in the store as a candidate item (Operation S303). For example, the ranking may be set based on at least one of sales volume or sales amount in the genre. According to another item, the item selecting part 67 selects a predetermined number or a plurality of items having highest ranks (or ranks above a threshold value) as candidate items.

The item selecting part 67 deletes or removes, from among selected items in genres related to genres of respective items in the action history, an item overlapping with an item selected from the other action history (Operation S304).

Further, the item selecting part 67 selects an item in stock from among the candidate items (Operation S305), and the list addition part 58 adds the selected item to the list.

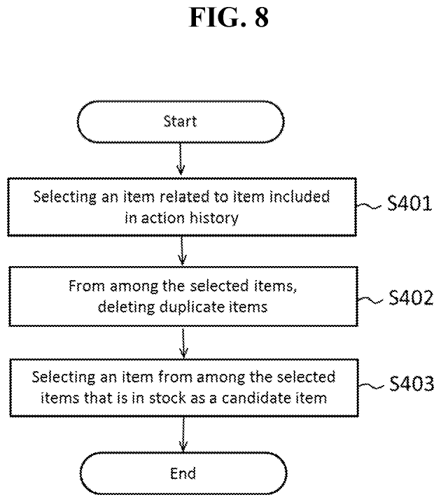

The processing of Operation S206 will now be described in detail with reference to FIG. 8. FIG. 8 is a diagram showing an example of the processing of the item utilization part 62. Referring to FIG. 8, the item selecting part 69 included in the item utilization part 62 selects an item related to an item included in the action history and handled in (or sold by or through) the store based on the set of a plurality of mutually related items determined by the related item determination part 53 (Operation S401). Here, the item utilization part 62 may select a common related item for plural items included in the action history, may select at least one related item for each item included in the action history, may select at least one related item for each of plural (but not all) items included in the action history, or may select at least one related item for only one item included in the action history. The item selecting part 69 deletes duplicate items from among the selected items (Operation S402), and selects an item in stock among the selected items as a candidate item (Step S403). The item selecting part 69 may select or obtain a single candidate item or plural candidate items from among the selected items, e.g., according to preset conditions. The list addition part 58 adds the candidate item(s) to the list (e.g., a list of items to present or suggest to a user) (S206 in FIG. 4).

Referring back to FIG. 4, if the purchase history is not acquired in Operation S202 (N in Operation S203), the process proceeds to Operation S207.

Based on the browsing history being acquired (Y in Operation S207), the genre utilization part 61 included in the related candidate acquisition part 57 selects an item as a candidate item based on the browsing history and the related genre, and the list addition part 58 adds the selected candidate item to the list (Operation S208). An exemplary embodiment of the processing of Operation S208 is described above with reference to FIG. 7, but with the browsing history instead of the purchase history as the action history. The item utilization part 62 included in the related candidate acquisition part 57 selects or determines an item as a candidate item based on the browsing history and the related item, and the list addition part 58 adds the selected candidate item to the list (Step S209). An exemplary embodiment of the processing of Operation S209 is described above with reference to FIG. 8, but with the browsing history instead of the purchase history as the action history. Based on the processes in Operations S208 and S209 being performed, the process proceeds to Operation S219 (FIG. 5).

If the browsing history is not acquired in Operation S202 (N in Operation S207), the process proceeds to Operation S210 (FIG. 5).

The processes described in Operations S210 to S217 of FIG. 5 are the processes in the case where the purchase history and the browsing history do not exist or are not obtained for the store accessed by the user.

Referring to FIG. 5, in Operation S210, the user history acquisition part 55 acquires the purchase history and/or the browsing history of the user at another store, e.g., a store related to the store currently accessed by the user, another store recently visited (e.g., last visited or visited within a predetermined time period) by the user, most frequently visited by the user, etc. (Operation S210). If neither the purchase history nor the browsing history can be acquired (N in Operation S211), since the recommendation based on the purchase history or the browsing history cannot be performed, the list addition part 58 adds one or more items of the store accessed by the user according to a predetermined criteria, e.g., a predetermined number of highest ranking items ranked by sales (Operation S212).

On the other hand, when the purchase history is acquired (Y in Operation S211 and Y in Operation S213), the genre utilization part 61 included in the related candidate acquisition part 57 selects one or more candidate items from items sold by or through the store being currently accessed by the user, based on the purchase history in the other store and one or more related genres, and adds the selected candidate item(s) to the list (Operation S215). An exemplary embodiment of the processing of Operation S215 is described above with reference to FIG. 7, using the purchase history in the other store as the action history. By way of example, if a user is accessing the webpage of store S (as shown in FIG. 11), the genre utilization part 61 selects candidate items from genre A that are sold in store S. Here, the genre A is related to a genre B of an item previously purchased by the user in the other store S′. The genre utilization part 61 adds the selected candidate items to a list for displaying to the user on the webpage of store S. Alternatively (or additionally), the item utilization part 62 selects one or more candidate items from items sold by or through the store based on the purchase history in the other store and one or more related items, and adds the selected candidate item(s) to the list. An exemplary embodiment of the processing of such a related item selection is described above with reference to FIG. 8, using the purchase history in the other store as the action history.

If the purchase history has not been acquired (N in Operation S211 or N in Operation S213), then Operation S215 is not performed.

When the browsing history is acquired (Y in Operation S211 and Y in Operation S216), the genre utilization part 61 included in the related candidate acquisition part 57 selects one or more candidate items from items sold by or through the store based on the browsing history in the other store and one or more related genres, and adds the selected candidate item(s) to the list (Operation S217). An exemplary embodiment of the processing of Operation S217 is described above with reference to FIG. 7, using the browsing history in the other store as the action history. By way of example, if a user is accessing the webpage of store S (as shown in FIG. 11), the genre utilization part 61 selects candidate items from genre A that are sold in store S. Here, the genre A is related to a genre B of an item previously browsed by the user in the other store S′. The genre utilization part 61 adds the selected candidate items to a list for displaying to the user on the webpage of store S. Alternatively (or additionally), the item utilization part 62 selects one or more candidate items from items sold by or through the other store based on the purchase history in the other store and one or more related items, and adds the selected candidate item(s) to the list. An exemplary embodiment of the processing of such a related item selection is described above with reference to FIG. 8, using the browsing history in the other store as the action history.

If the browsing history has not been acquired (N in Operation S211 or N in Operation S216), then Operation S217 is not performed, and the process proceeds to step 219.

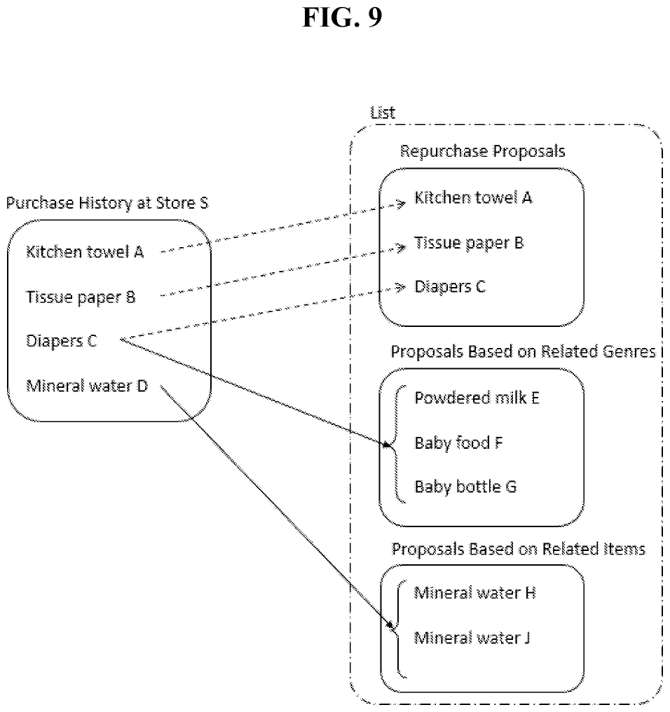

Specific examples of items added to the list in Operations S202 to S217 will now be described with reference to FIG. 9.

FIG. 9 is a diagram showing an example of the relationship between a purchase history of a user in a store S and an item added to a list (e.g., a list of items to be proposed or suggested to a user for purchase) for the user, according to an embodiment. It is assumed that the store S is a store accessed by the user. In the example shown in FIG. 9, the purchase history of the user in the store S, and items included in the purchase history are a kitchen towel A, tissue paper B, diapers C, and mineral water D. The list includes items acquired or obtained by the repurchase candidate acquisition part 56 (corresponding to a first selection method), such as a kitchen towel A, tissue paper B, and paper diaper C (See “Repurchase Proposals” in FIG. 9); items selected by the genre utilization part 61 included in the related candidate acquisition part 57 (corresponding to a second selection method), such as powdered milk E, baby food F, and baby bottle G (See “Proposals Based on Related Genres” in FIG. 9); and items selected by the item utilization part 62 included in the related candidate acquisition part 57 (corresponding to the second selection method), such as mineral water H and mineral water J (See “Proposals Based on Related Items in FIG. 9”). In FIG. 9, it is assumed or determined by the system that the item at the top of each section has a highest rank among items in that section.

The kitchen towel A, the tissue paper B and the diapers C added to the list are determined to be highly likely to be repurchased among the items included in the purchase history in the store S of the user (e.g., having a calculated or obtained repurchase probability value that is greater than a predetermined threshold, and/or having one of the highest X repurchase probability values where X is a predetermined integer). In the present exemplary embodiment, mineral water D, which is determined by the system to be unlikely to be repurchased, has not been added to the list.

In the present exemplary embodiment, diapers C belong to the genre of “diapers,” and powdered milk E, baby food F, and baby bottle G respectively belong to the genres of “powdered milk,” “baby food,” and “infant goods,” respectively. A genre of “diapers” and genres of “powdered milk,” “baby food” and “infant goods” are related to each other, and the genre utilization part 61 of the related candidate acquisition part 57 selects powdered milk E, baby food F and baby bottle G which are items with the highest rank in each genre related to “diaper” as candidates for proposal. Here, the genre utilization part 61 does not select the item as a candidate when the item with the highest rank is out of stock. In this case, the genre utilization part 61 may select the item with the highest rank among the items in stock as a candidate. The item utilization part 62 of the related candidate acquisition part 57 selects mineral water H and mineral water J related to mineral water D as candidates to be proposed. The item utilization part 62 does not select an item that is out of stock as a candidate.

By selecting an item to be proposed based not only on related items but also related genres, the scope or range of items to be proposed to the user is expanded, and the possibility that the proposed item is appropriate according to the situation, wants, or needs of the user is increased. Thus, the user can reduce the labor for retrieving the item and improve the usability while increasing the possibility of purchasing the item. Further, ease of access of a store by the user is increased and a user's consumption of time to search for and obtain items is decreased by providing proposals of candidate items according to exemplary embodiments. Similarly, a power usage and processing load on a user's client device is decreased by virtue of providing the proposals of candidate items for purchase on a screen of the store. This is because a user no longer needs to expend time and compute power navigating through multiple pages to search for items to purchase. The information processing server to which the item purchased or browsed by the user is inputted or obtained automatically outputs the item to be proposed by referring to a set including a plurality of genres related to each other. Thus, the item to be proposed to the user can be acquired at high speed and with high accuracy. Since the number of genres is smaller than the number of items, the amount of data processed by the information processing server can be reduced and the processing load can be reduced.

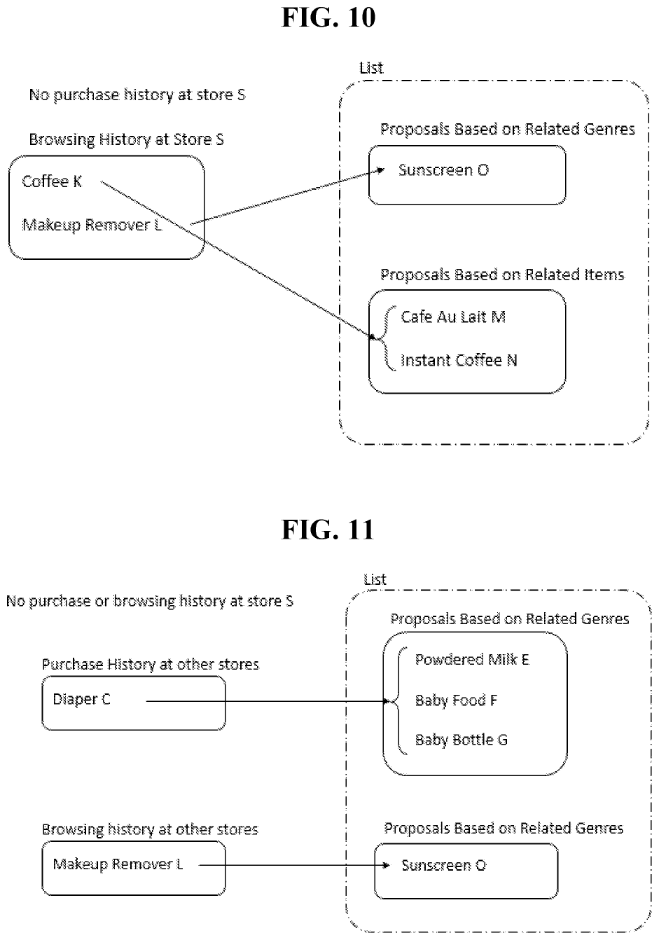

FIG. 10 is a diagram showing an example of the relationship between a purchase history and a browsing history in a store S and items added to the list. In the example shown in FIG. 10, user does not have a purchase history for the store S, but does have a browsing history. The items included in the browsing history may include, for example, coffee K and makeup remover L. Since the genre “makeup remover” to which the makeup remover L belongs and the genre “sunscreen” to which the sunscreen O belongs are related to each other, the sunscreen O is selected as a candidate on this basis. In the present exemplary embodiment, candidates are selected by two methods (e.g., first and second selection methods): the selection of an item to be proposed based on genres related to each other by the genre utilization part 61 and the selection of an item to be proposed based on items related to each other by the item utilization part 62. Even when the purchase history of the user exists in the store S, the candidate may be selected based on the browsing history.

FIG. 11 is a diagram showing an example of the relationship between a purchase history and a browsing history and an item added to the list. In the example shown in FIG. 11, neither the purchase history nor the browsing history of the user exists in the store S. However, the user has a purchase history and a browsing history in other stores. The purchase history in other stores includes a diaper C, and the browsing history includes a makeup remover L. In this case, the genre utilization part 61 of the related candidate acquisition part 57 selects candidates by two selection methods of selecting candidates based on purchase history and selecting candidates based on browsing history. Note that even when the purchase history or browsing history of the user exists in the store S, a candidate item may additionally or alternatively be selected based on the purchase history or browsing history in another store.

The information processing server 1 can select candidate items in the store S by various selection methods based on purchase history or browsing history in other stores. For example, when the store S sells an item included in a purchase history or a browsing history of a user in another store, the same item as the item included in the purchase history or the browsing history of the user in the other store may be selected as a candidate item in the store S. In this case, among the items included in the purchase history of the user in the other store, an item having a high possibility of repurchase may be selected as a candidate item in the store S. For example, the genre utilization part 61 included in the related candidate acquisition part 57 may select candidate items in the store S according to genres related to each other based on the purchase history or browsing history of the user in another store. Further, the item utilization part 62 included in the related candidate acquisition part 57 may select the candidate item in the store S according to items related to each other based on the purchase history or the browsing history of the user in the other store.

By selecting a candidate item in a store accessed by a user based on a purchase history or a browsing history of the user in another store, an appropriate item considering the purchase history or the browsing history of the user in the other store can be proposed. Thus, the user can reduce the labor for retrieving the item and improve the usability while increasing the possibility of purchasing the item.

Referring back to FIG. 5, in Operation S219, the output part 59 causes, instructs, or controls a display device of the client device 2 or connected to the client device 2 to output a proposal user interface (e.g., screen) including the list. Here, the output part 59 may output the proposal screen so that the candidate items included in the list are arranged at positions corresponding to a particular order (e.g., their order or ranking in the list). For example, the proposal screen is a screen displayed on the web page of the store accessed by the user, such as a web page of the store within an online commerce or retail website through which a plurality of stores are accessible or through which items sold by a plurality of stores may be purchased.

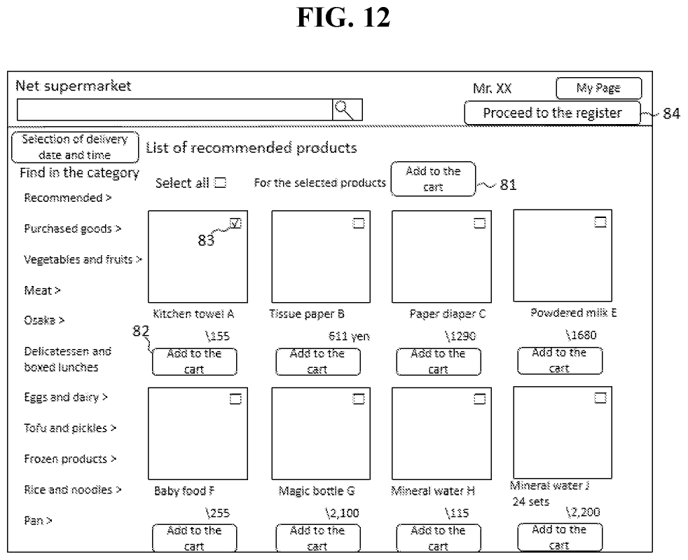

FIG. 12 is a diagram showing an example of an output proposal screen. On the proposal screen, a plurality of addition buttons 81 and 82 and a register button 84 (or checkout button) are arranged, and a plurality of items included in the list are arranged. Each of the items is arranged with an individual add button 82 and a check box 83, though this is only an example.

The individual add button 82 is a button for instructing the user to add a corresponding item to the cart. The check box 83 is a button for checking the corresponding item, and the multiple add button 81 is a button for instructing to add the item(s) corresponding to the check box(es) 83 checked when pressed to the cart. The register button 84 is a button for instructing the start of purchase processing for the item(s) added to the cart. When either the individual addition button 82 or the register button 84 is selected or pressed, the client device 2 transmits information corresponding to the pressed button to the information processing server 1. When the multiple add button 81 is pressed, the client device 2 transmits information indicating an item corresponding to a check box 83 checked when the button is pressed and information corresponding to the pressed button to an information processing server 1.

On the proposal screen, candidate items selected by a plurality of methods and added to the same list are collectively displayed, for example, candidates based on a genre associated with or related to a repurchase candidate. Thus, since the items of interest to a user are gathered and provided on one site, the burden and inconvenience to the user and processing load on the user's device can be reduced. The information processing server transmits the candidate items selected by the plurality of methods to the client device as data of the same list instead of data of different lists. Thus, since the amount of data transmitted from the information processing server to the client device can be reduced, the communication load can be reduced, and the display processing of the proposal screen in the client device can be accelerated.

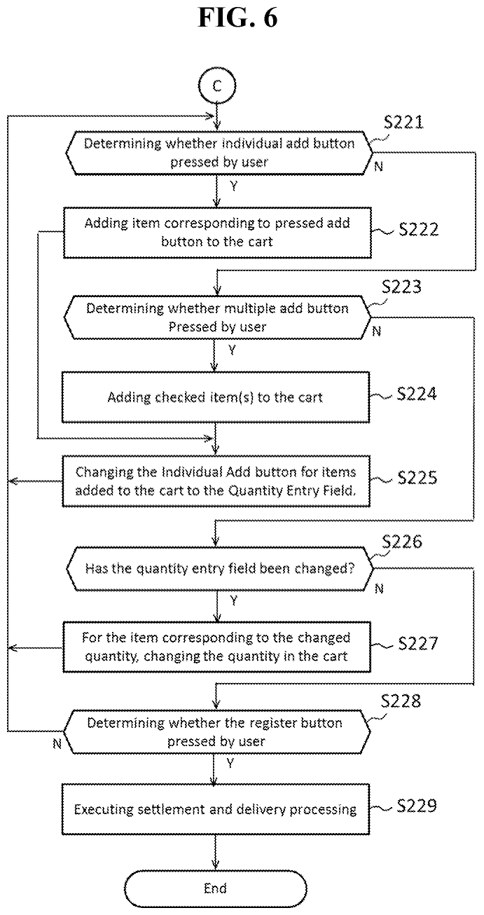

Processing when the user operates the proposal screen will now be described with reference to FIG. 6.

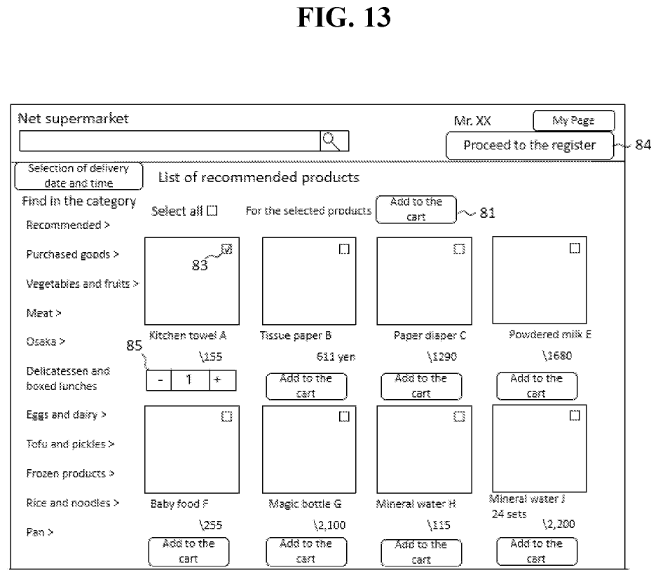

Referring to FIG. 6, in Operation S221, the cart control part 60 (or cart controller) determines whether the individual add button 82 has been pressed by the user. When (or based on) the individual add button 82 is pressed (Y in Operation S221), the cart control part 60 adds an item corresponding to the pressed individual add button 82 to the cart (Operation S222). Then, the process proceeds to Operation S225, where the output part 59 changes the individual add button 82 of the item added to the cart to the quantity input column 85 (See FIG. 13). The change to the quantity input field 85 may be realized by the client device 2 executing the program transmitted together with the data of the proposal screen and replacing the displayed individual add button 82 with the quantity input field 85, or may be realized by the information processing server 1 transmitting the data of the proposal screen in which the individual add button 82 is replaced with the quantity input field 85 to the client device 2 and the client device 2 displaying the proposal screen.

FIG. 13 is a diagram showing an example of a proposal screen after an item is added to a cart. In the example of FIG. 13, when the individual add button 82 is pressed for the item in the upper left among the items proposed in FIG. 12, the individual add button 82 is changed to the quantity input field 85.

If the individual add button 82 is not pressed (N in Operation S221), the cart control part 60 determines whether the multiple add button 81 is pressed (Operation S223). When (or based on) the multiple add button 81 is pressed (Y in Operation S223), the cart control part 60 adds the item whose corresponding check box 83 is checked to the cart (Operation S224). In Operation S225, the output part 59 changes the individual add button(s) 82 of the item(s) added to the cart to the quantity input field 85.

When the process of Operation S225 is performed, the processes after Operation S221 are repeated.

On the other hand, if the multiple add button 81 is not pressed (N in Operation S223), the cart control part 60 determines whether the quantity input field 85 has been changed (Operation S226). When the quantity input column 85 is changed (Y in Operation S226), the cart control part 60 changes the quantity in the cart of the item corresponding to the changed quantity input field 85 (Operation S227). Thereafter, the processes from Operation S221 are repeated.

If the quantity input field 85 has not been changed (N in Operation S226), the cart control part 60 determines whether the register button 84 has been pressed (Operation S228). When the register button 84 is pressed (Y in Operation S228), the cart control part 60 executes a process related to the purchase of an item present in the cart, more specifically, a process related to settlement and delivery (Operation S229). On the other hand, if the register button 84 is not pressed (N in Operation S228), the processes from Operation S221 onward are repeated.

Although embodiments of the present disclosure have been described, it is understood that the present disclosure is not necessarily limited to these embodiments. For example, the item may be not only an actual product to be sold, but also a content to be transmitted as data. Further, it is understood that one or more features of an embodiment described or ascertainable from the above may be omitted, and/or one or more features of one embodiment may be added to another embodiment.

What is claimed is:

1. An information processing system comprising:
at least one memory configured to store computer program code; and
at least one processor configured to execute the computer program code to:
acquire an action history of a user in relation to a store, the action history including at least one of a purchase history including an item purchased by the user from the store and a browsing history including an item browsed by the user in the store;
select, based on the acquired action history, a first item from among a first plurality of items by a first selection method;
select, based on the acquired action history, one or more second items from among a second plurality of items by a second selection method different from the first selection method;
add the first item and the one or more second items to a list; and
output the list for display to the user on a screen for recommending items of interest to the user and allowing the user to purchase the items via the screen.

2. The information processing system according to claim 1, wherein the at least one processor is further configured to execute the computer program code to:
arrange the first item and the one or more second items in the list at positions corresponding to recommendation rankings determined therefor.

3. The information processing system according to claim 2, wherein the at least one processor is further configured to execute the computer program code to:
add to a cart an item selected by the user from among the first item and the one or more second items displayed on the screen.

4. The information processing system according to claim 3, wherein the at least one processor is further configured to execute the computer program code to:
add the item selected by the user from among the displayed first item and the one or more second items to the cart based on an add button displayed on the screen being pressed.

5. The information processing system according to claim 1, wherein the at least one processor is further configured to execute the computer program code to:
select at least one of items included in the purchase history as the first item; and
select at least one of items different from the items included in the purchase history and different from items included in the browsing history as the one or more second items.

6. The information processing system according to claim 5, wherein the at least one processor is further configured to execute the computer program code to:
arrange the first item before the one or more second items in the list.

7. The information processing system according to claim 5, wherein the at least one processor is further configured to execute the computer program code to:
obtain a repurchase probability value for each of the items included in the purchase history, the repurchase probability value indicative of a probability of repurchase;
select as said first item an item included in said purchase history that has a corresponding repurchase probability value determined to satisfy a predetermined condition.

8. The information processing system according to claim 7, wherein the at least one processor is further configured to execute the computer program code to:
acquire the repurchase probability value based on a past purchase date of the item by the user.

9. The information processing system according to claim 5, wherein the at least one processor is further configured to execute the computer program code to:
arrange, in the list, an item from among the one or more second items selected based on the purchase history before another item from among the one or more second items selected based the browsing history.

10. The information processing system according to claim 1, wherein:
the second selection method includes a method for selecting a second item based on a relationship between a first genre of an item included in the action history and a second genre of the second item, and a different method of selecting an other second item based on a relationship between the item included in the action history and the other second item.

11. The information processing system according to claim 1, wherein the at least one processor is further configured to execute the computer program code to:
select the first item based on the purchase history of the user at another store different from a store to which the user is accessing; and
select the one or more second items based the browsing history of the user in the other store.

12. The information processing system according to claim 1, wherein the at least one processor is further configured to execute the computer program code to:
select the first item from among items included in the purchase history or the browsing history at another store different from a store to which the user is accessing; and
select the one or more second items based on the purchase history or the browsing history of the user in the other store.

13. An information processing method comprising
acquiring an action history of a user in relation to a store, the action history including at least one of a purchase history including an item purchased by the user from the store and a browsing history including an item browsed by the user in the store;
selecting, based on the acquired action history, a first item from among a first plurality of items by a first selection method;
selecting, based on the acquired action history, one or more second items from among a second plurality of items by a second selection method different from the first selection method;
adding the first item and the one or more second items to a list; and
outputting the list for display to the user on a screen for recommending items of interest to the user and allowing the user to purchase the items via the screen.

14. The information processing method according to claim 13, wherein the second selection method includes a method for selecting a second item based on a relationship between a first genre of an item included in the action history and a second genre of the second item, and a different method of selecting an other second item based on a relationship between the item included in the action history and the other second item.

15. The information processing method according to claim 14, wherein the first selection method is a method for selecting the first item from among items included in the action history.

16. A non-transitory computer-readable medium storing instructions that, when executed by one or more processors of a device, cause the one or more processors to:
acquire an action history of a user in relation to a store, the action history including at least one of a purchase history including an item purchased by the user from the store and a browsing history including an item browsed by the user in the store;
select, based on the acquired action history, a first item from among a first plurality of items by a first selection method;
select, based on the acquired action history, one or more second items from among a second plurality of items by a second selection method different from the first selection method;
add the first item and the second item to a list; and
output the list for display to the user on a screen for recommending items of interest to the user and allowing the user to purchase the items via the screen.

17. The non-transitory computer-readable medium according to claim 16, wherein the second selection method includes a method for selecting a second item based on a relationship between a first genre of an item included in the action history and a second genre of the second item, and a different method of selecting an other second item based on a relationship between the item included in the action history and the other second item.

18. The non-transitory computer-readable medium according to claim 17, wherein the first selection method is a method for selecting the first item from among items included in the action history.
